(19) United States
(12) Patent Application Publication
(10) Pub. No.: US 2004/0021909 A1
(43) Pub. Date: Feb. 5, 2004

(54) Image information distributing method, image information distributing system, central apparatus, terminal apparatus, scanner apparatus, and computer memory product

(75) Inventor: Yumiko Kikuoka, Nara-shi (JP)

Correspondence Address: Dike, Bronstein, Roberts & Cushman, Intellectual Property Practice Group, Edwards & Angell, LLP, P. O. Box 9169, Boston, MA, 02209, US

(73) Assignee: Sharp Kabushiki Kaisha

(21) Appl. No.: 10/622,273

(22) Filed: Jul. 17, 2003

(30) Foreign Application Priority Data
Jul. 19, 2002 (JP) 2002-211807

(51) Int. Cl. B41F 1/00; G06F 15/00; H04N 1/00

(52) U.S. Cl. 358/402; 358/1.15

(57) ABSTRACT

An information processing apparatus 30 obtains a summary document including summary image information obtained by reducing image information stored in a server 20 (step S152) and displays the summary image information or the like included in the summary document (step S153). When a receiving instruction of image information corresponding to the summary image information is inputted by the user who recognizes the summary image information (YES in step S154), the image information is received from the server 20 (step S159). By such processings, an image information distributing method, an image information distributing system, a central apparatus, a terminal apparatus, a scanner apparatus, and a computer memory product capable of transmitting only image information required by the user and preventing traffic of a transmission path from increasing are realized.

### BACKGROUND OF THE INVENTION

1. Field of the Invention

The present invention relates to an image information distributing method for distributing image information generated by a scanner apparatus to a terminal apparatus via a central apparatus, an image information distributing system, a central apparatus, a terminal apparatus, a scanner apparatus and a computer memory product.

2. Description of Related Art

Conventionally, an image information distributing system in which a scanner apparatus and one or a plurality of terminal apparatus (for example, personal computers) are connected to each other via a LAN is used.

The conventional image information distributing system attaches image information generated by reading an image of an original by the scanner apparatus as an attached file to an E-mail and transmits the E-mail to a requiring terminal apparatus.

Even in the case where a number of users requiring image information exist, such an image information distributing system can distribute image information to terminal apparatus of each of the users.

In an image input/output system disclosed in Japanese Patent Application Laid-Open No. 2000-349952, an image input/output apparatus which inputs image information from a scanner apparatus stores the inputted image information into a storage device. The image input/output apparatus generates a hyper text, generates an E-mail in which location information (for example, URL) indicative of the location in which the generated hyper text is stored is written or attached as an attached file, and transmits the E-mail to a requiring terminal apparatus.

The above-mentioned hyper text has the function of displaying reduced image information obtained by reducing image information, accepting information indicating whether image information is acquired or not and, in the case where the image information is acquired, outputting image information corresponding to location information indicative of the location in which image information is stored from the image input/output apparatus.

The user who obtained the location information by the terminal apparatus which has received an E-mail receives a hyper text corresponding to the location information by using the terminal apparatus from the image input/output apparatus, and views the reduced image information possessed by the hyper text. At this time, the user determines whether or not to acquire image information (original image information) corresponding to the reduced image information and, when the user wants to acquire the original image information, makes the original image information to be outputted from the image input/output apparatus by using the hyper text.

The conventional image input/output system as described above outputs only image information necessary for the user from the image input/output apparatus without distributing image information unnecessary for the user to the terminal apparatus of the user. Thus, traffic of a transmission path can be decreased and efficiency of image information distribution can be improved.

In the conventional image information distributing system, however, there is a case in that each terminal apparatus receives not only image information necessary for the user but also unnecessary image information. Consequently, there is a problem in that traffic of the transmission path increases, efficiency of image information distribution decreases, and convenience of the user deteriorates.

In the image input/output system disclosed in above-mentioned Japanese Patent Application Laid-Open No. 2000-349952, information distributed to the user as image information is location information of reduced image information and there is a problem in that the contents of the image information cannot be known only from the location information. Consequently, in order to know the contents of the image information (in order to see the reduced image information) to determine whether image information stored in the image input/output apparatus is necessary or not, the user has to receive a hyper text having the reduced image information from the image input/output apparatus by using the location information, so that a problem of increase in traffic of a transmission path arises.

### BRIEF SUMMARY OF THE INVENTION

The present invention has been achieved to solve the problems, and a main object of the present invention is to provide an image information distributing method and an image information distributing system by attaching a summary document including summary image information and/or character information corresponding to image information stored in a central apparatus and location information of the image information to an E-mail, and transmitting the summary document to a requiring terminal apparatus, thereby preventing image information unnecessary for the user from being transmitted to the terminal apparatus of the user, accordingly preventing increase in traffic of a transmission path, and improving convenience of the user in the case where the user determines whether image information stored in the central apparatus is necessary or not. Also, an object of the present invention is to provide be, a central apparatus, a terminal apparatus and a scanner apparatus constructing the system and, further, a computer memory product in which a computer program for making a general purpose computer function as the central apparatus or the terminal apparatus is recorded.

Another object of the present invention is to provide an image information distributing method and an image information distributing system capable of preventing traffic of a transmission path from increasing by displaying summary image information and/or character information on displaying means of a terminal apparatus when the user determines whether image information stored in the central apparatus is necessary or not, and also to provide a central apparatus, a terminal apparatus and a scanner apparatus constructing the system and, further, a computer memory product in which a computer program for making a general purpose computer function as the central apparatus or the terminal apparatus is recorded.

Still another object of the present invention is to provide an image information distributing method and an image information distributing system in which, when a receiving instruction of image information is inputted to a terminal apparatus, the terminal apparatus instructs a central apparatus to transmit the image information to itself, in such a manner the user can easily acquire image information when the image information stored in the central apparatus is necessary, and also to provide a central apparatus, a terminal apparatus and a scanner apparatus constructing the system and, further, a computer memory product in which a computer program for making a general purpose computer function as the central apparatus or the terminal apparatus is recorded.

An image information distributing method according to the present invention is an image information distributing method for receiving image information stored in a central apparatus by one or a plurality of terminal apparatus, characterized by comprising the steps of: generating, by using said image information stored in said central apparatus, summary image information whose information amount is smaller than said image information; generating a summary document including location information indicative of a location in which said image information is stored and said summary image information; generating a summary E-mail by attaching said generated summary document to an E-mail; and transmitting said generated summary E-mail to said one or a plurality of terminal apparatus.

The image information distributing method according to the present invention is the image information distributing method as described above and characterized by further comprising the steps of: determining whether character information is included in said image information or not; and in the case where character information is included in said image information, making said character information to be included in said summary document.

The image information distributing method according to the present invention is the image information distributing method as described above and characterized in that said terminal apparatus comprises displaying means, the summary image information and/or character information included in the received summary document is displayed on said displaying means.

The image information distributing method according to the present invention is the image information distributing method as described above and characterized in that said terminal apparatus accepts input of a receiving instruction for requesting reception of image information corresponding to the received summary image information and/or character information, and, when said receiving instruction is inputted, in response to the summary image information and/or character information corresponding to the image information requested to be received, transmits to said central apparatus a transmitting instruction including the location information included in the received summary document, and said central apparatus, when the transmitting instruction is received, transmits image information stored in a location indicated by the location information included in the received transmitting instruction to the terminal apparatus which has transmitted the received transmitting instruction.

An image information distributing system according to the present invention is an image information distributing system in which a scanner apparatus for generating image information by reading an image of an original and transmitting said image information, a central apparatus for receiving and storing the image information transmitted from said scanner apparatus, and one or a plurality of terminal apparatus for receiving the image information transmitted from said central apparatus are connected via communicating means, characterized in that any of said scanner apparatus, said central apparatus and said terminal apparatus comprises: summary document generating means having means for generating, by using said image information generated by said scanner apparatus, summary image information whose information amount is smaller than said image information, and means for generating a summary document including location information indicative of a location in which said image information generated by said scanner apparatus is stored and said summary image information; and E-mail processing means having means for generating a summary E-mail by attaching said generated summary document to an E-mail, and means for transmitting the generated summary E-mail to said terminal apparatus.

The image information distributing system according to the present invention is the image information distributing system as described above and characterized in that said summary document generating means comprises: means for determining whether character information is included in said image information or not; and means, in the case where character information is included in said image information, for making said character information to be included in said summary document.

The image information distributing system according to the present invention is the image information distributing system as described above and characterized in that said terminal apparatus comprises displaying means, and said summary document processing means is provided on said terminal apparatus and displays summary image information and/or character information included in the summary document onto said displaying means.

The image information distributing system according to the present invention is the image information distributing system as described above and characterized in that said summary document processing means comprises: means for accepting input of a receiving instruction for requesting reception of image information corresponding to said summary image information and/or character information; and means for, when said receiving instruction is inputted, in response to the summary image information and/or character information corresponding to the image information requested to be received, transmitting to said central apparatus a transmitting instruction including the location information included in the received summary document, and said central apparatus comprises means for, when the transmitting instruction is received, transmitting image information stored in a location indicated by the location information included in the received transmitting instruction to the terminal apparatus which has transmitted the received transmitting instruction.

The image information distributing system according to the present invention is the image information distributing system as described above and characterized in that said summary document generating means and said E-mail processing means are provided on said central apparatus.

The image information distributing system according to the present invention is the image information distributing system as described above and characterized in that said summary document generating means and said E-mail processing means are provided on said scanner apparatus.

The image information distributing system according to the present invention is the image information distributing system as described above and characterized in that said scanner apparatus comprises means for transmitting said image information to a predetermined terminal apparatus, said summary document generating means and said E-mail processing means are provided on said predetermined terminal apparatus, and said predetermined terminal apparatus further comprises means for receiving the image information transmitted from said scanner apparatus.

A central apparatus according to the present invention is a central apparatus having means for, by connecting to communicating means, performing communication, and storing means for storing image information received via said means, characterized by comprising: means for, when a transmitting instruction including location information is received, transmitting the image information stored in a location in said storing means indicated by the location information included in the received transmitting instruction.

The central apparatus according to the present invention is the central apparatus as described above and characterized by further comprising: summary document generating means having means for, by using received image information, generating summary image information whose information amount is smaller than said image information, and means for generating a summary document including location information indicative of a location in said storing means in which said image information is stored and the generated summary image information; and E-mail processing means having means for generating a summary E-mail by attaching the generated summary document to an E-mail, and means for transmitting the generated summary E-mail.

A terminal apparatus according to the present invention is a terminal apparatus having means for, by connecting to communicating means, performing communication, characterized by comprising: means for receiving image information; summary document generating means having means for, by using the received image information, generating summary image information whose information amount is smaller than said image information, and means for generating a summary document including location information indicative of a location in which said image information is stored and said summary image information; and E-mail processing means having means for generating a summary E-mail by attaching the generated summary document to an E-mail, and means for transmitting the generated summary E-mail.

A terminal apparatus according to the present invention is a terminal apparatus having displaying means, characterized by comprising summary document processing means for displaying onto said displaying means said summary image information and/or character information included in a summary document which includes summary image information and/or character information and location information corresponding to image information.

A terminal apparatus according to the present invention is the terminal apparatus as described above and characterized by further comprising means for, by connecting to communicating means, performing communication, wherein said summary document processing means comprises: means for accepting input of a receiving instruction for requesting reception of image information; and means for, when said receiving instruction is inputted, transmitting a transmitting instruction including the location information corresponding to the image information requested to be received.

A scanner apparatus according to the present invention is a scanner apparatus having means for, by connecting to communicating means, performing communication, generating image information by reading an image of an original, transmitting the image information via said means, characterized by comprising: summary document generating means having means for, by using said image information, generating summary image information whose information amount is smaller than said image information, and means for generating a summary document including location information indicative of a location in said storing means in which said image information is to be stored and said summary image information; and E-mail processing means having means for generating a summary E-mail by attaching the generated summary document to an E-mail, and means for transmitting the generated summary E-mail.

A computer memory product according to the present invention is a computer memory product in which a computer program for causing a computer to receive and store image information is recorded, said computer comprising means for, by connecting to communicating means, performing communication and storing means for storing information, characterized in that said computer program comprises the step for, when a transmitting instruction including location information is received, causing the computer to transmit image information stored in a location indicated by said location information.

A computer memory product according to the present invention is a computer memory product in which a computer program for causing a computer to transmit/receive information is recorded, said computer comprising means for, by connecting to communicating means, performing communication, characterized in that said computer program comprises the steps for: causing the computer to receive image information; causing the computer to generate, by using the received image information, summary image information whose information amount is smaller than said image information; causing the computer to generate a summary document including location information indicative of a location in which said image information is stored and said summary image information; causing the computer to generate a summary E-mail by attaching the generated summary document to an E-mail; and causing the computer to transmit the generated summary E-mail.

A computer memory product according to the present invention is a computer memory product in which a computer program for displaying information is recorded, said computer comprising displaying means, characterized in that said computer program comprises the step for causing the computer to display onto said displaying means summary image information and/or character information included in a summary document which includes the summary image information and/or character information and location information corresponding to image information.

In the present invention, the scanner apparatus reads an image of an original, generates image information, and transmits the generated image information to the central apparatus. Alternately, image information is transmitted to another apparatus (for example, terminal apparatus) and, from the apparatus, the image information is transmitted to the central apparatus.

The central apparatus comprises means for receiving information and storing means for storing information, and stores received image information into the storing means.

The summary document generating means generates summary image information whose information amount is smaller than image information by using the image information. Such summary image information is, for example, a part of image information, information obtained by compressing or reducing image information, information obtained by decreasing resolution, the number of colors, or the like of image information, information obtained by re-editing image information so as to be summarized, or the like. A summary document including summary image information, and location information corresponding to the summary image information, concretely, location information (for example, URL) indicative of the location in which the original image information of the summary image information is stored is generated. In this case, the summary document is generated so that its information amount becomes smaller than that of image information, concretely, so that the file size is decreased.

The E-mail processing means generates an E-mail (hereinafter, referred to as summary mail) to which a summary document is attached as an attached file by using a known technique and transmits the summary mail to one or a plurality of terminal apparatus connected to the image information distributing system.

The summary mail thus transmitted is received by the terminal apparatus.

In the case of using the image information distributing system of the present invention as described above, since the information amount of the summary document is smaller than that of image information, also in the case where a summary mail is transmitted to distribute image information to a number of terminal apparatus, traffic of a transmission path can be decreased as compared with the case of transmitting an E-mail to which image information itself is attached.

According to the present invention, the summary document generating means determines whether character information is included in the image information or not. When character information is included, the summary document generating means recognizes the character information by using known character recognizing means such as an OCR.

In short, the summary document generating means generates a summary document including summary image information, character information included in the summary image information, and location information indicative of the location in which the original image information of the summary image information is stored. In this case, the summary document is generated so that its information amount becomes smaller than that of original image information.

In the case of using the image information distributing system of the present invention as described above, by using a terminal apparatus comprising displaying means and means for displaying summary image information and character information included in the summary document onto the displaying means, the user can view the summary image information and character information and, also, know the contents of the image information stored in the central apparatus. Thus, the user can easily determine whether the image information is necessary or not. By retrieving the character information with a keyword related to the contents of necessary image information, the user can easily determine whether summary image information corresponding to image information is included in the summary document or not.

Further, according to the present invention, the terminal apparatus includes, for example, a known mailer, and receives, by using the mailer, a summary mail and obtains the summary document attached to the received summary mail. The terminal apparatus comprises displaying means and summary document processing means for displaying summary image information and/or character information included in the summary document onto the displaying means.

In the case of using the image information distributing system of the present invention as described above, the user can view summary image information and/or character information by using summary document processing means of a terminal apparatus which has received a summary mail directly from the image information distributing system or summary document processing means of another terminal apparatus which has obtained the summary mail or the summary document attached to the summary mail from above-said terminal apparatus. Thus, the user can know the contents of image information stored in the central apparatus and easily determine whether the image information is necessary or not.

In the case where a terminal apparatus receives a summary mail directly from the image information distributing system, it is unnecessary to obtain the summary mail or summary document from another terminal apparatus, so that convenience of the user can be improved and efficiency of image information distribution can be improved. Further, at the time of viewing summary image information and/or character information by the user, communication is not performed between the terminal apparatus used by the user and another apparatus. Consequently, increase in traffic of a transmission path can be prevented.

According to the present invention, the summary document processing means provided for the terminal apparatus comprises means for accepting input of a receiving instruction of image information corresponding to summary image information.

When the receiving instruction is inputted, the summary document processing means transmits a transmitting instruction including location information corresponding to the summary image information instructed to be received to the central apparatus.

When the transmitting instruction is received, the central apparatus transmits image information stored in the location indicated by the location information included in the received transmitting instruction to the terminal apparatus which has sent the transmitting instruction.

The terminal apparatus which has sent the transmitting instruction receives the image information transmitted from the central apparatus.

In the case of using the image information distributing system of the present invention as described above, when image information corresponding to summary image information is necessary, the user can acquire the image information by using the terminal apparatus which has received the summary mail and by operating a reception start instruction button. Consequently, it is unnecessary to input the location information (for example, URL) and the convenience of the user can be improved.

Since both summary image information and location information is integrally included in a summary document, by using a terminal apparatus which has received the summary mail, summary image information and location information corresponding to the summary image information can be easily managed.

Further, only necessary image information can be selectively received by using the terminal apparatus which has received the summary mail, so that traffic of a transmission path can be decreased.

The above and further objects and features of the invention will more fully be apparent from the following detailed description with accompanying drawings.

### BRIEF DESCRIPTION OF THE SEVERAL VIEWS OF THE DRAWINGS

FIG. 1 is a configuration diagram of an image information distributing system according to Embodiment 1 of the present invention;

FIG. 2 is a block diagram of a scanner as a component of the image information distributing system according to Embodiment 1 of the present invention;

FIG. 3 is a block diagram of a server as a component of the image information distributing system according to Embodiment 1 of the present invention;

FIG. 4 is a block diagram of an information processing apparatus as a component of the image information distributing system according to Embodiment 1 of the present invention;

FIG. 5 is a schematic view showing an example of summary image information displayed on a display unit of the information processing apparatus as a component of the image information distributing system according to Embodiment 1 of the present invention;

FIG. 6 is a flowchart showing an image information transmitting procedure of the scanner as a component of the image information distributing system according to Embodiment 1 of the present invention;

FIG. 7 is a flowchart showing a summary mail transmitting procedure of the server as a component of the image information distributing system according to Embodiment 1 of the present invention;

FIG. 8 is a flowchart showing an image information transmitting/receiving procedure of the information processing apparatus and the server as components of the image information distributing system according to Embodiment 1 of the present invention;

FIG. 9 is a block diagram of a scanner as a component of an image information distributing system according to Embodiment 2 of the present invention;

FIG. 10 is a block diagram of a server as a component of the image information distributing system according to Embodiment 2 of the present invention;

FIG. 11 is a flowchart showing a summary mail transmitting procedure of the scanner as a component of the image information distributing system according to Embodiment 2 of the present invention;

FIG. 12 is a flowchart showing an image information storing procedure of the server as a component of the image information distributing system according to Embodiment 2 of the present invention;

FIG. 13 is a block diagram showing an information processing apparatus as a component of an image information distributing system according to Embodiment 3 of the present invention;

FIG. 14 is a schematic diagram showing an example of summary image information displayed on a display unit in an information processing apparatus as a component of the image information distributing system according to Embodiment 3 of the present invention; and

FIG. 15 is a flowchart showing a summary mail transmitting procedure of the information processing apparatus and the scanner as components of the image information distributing system according to Embodiment 3 of the present invention.

### DETAILED DESCRIPTION OF THE PREFERRED EMBODIMENTS

Hereinafter, the present invention will be described in detail with reference to the drawings showing preferred embodiments.

Embodiment 1

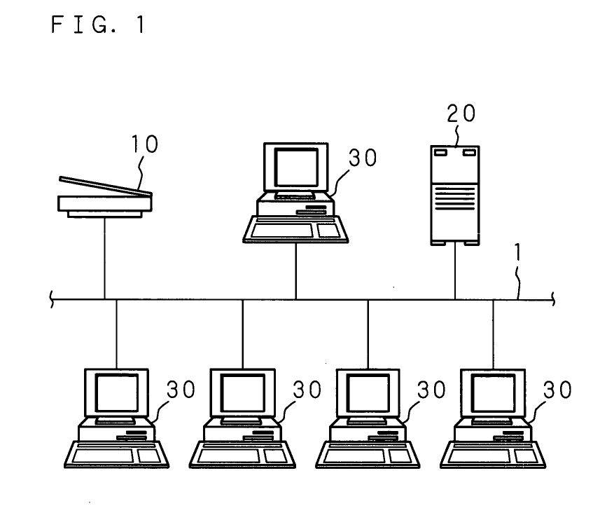

FIG. 1 is a configuration diagram of an image information distributing system according to Embodiment 1 of the present invention.

In the figure, the reference numeral 10 denotes a scanner. The scanner 10 is connected to a local area network (LAN) 1. To the LAN 1, a server 20 as a central apparatus is also connected. Information processing apparatus 30, 30, . . . which are personal computers as clients (terminal apparatus) of the server 20 and each of which has a peculiar mail address are also connected to the LAN 1.

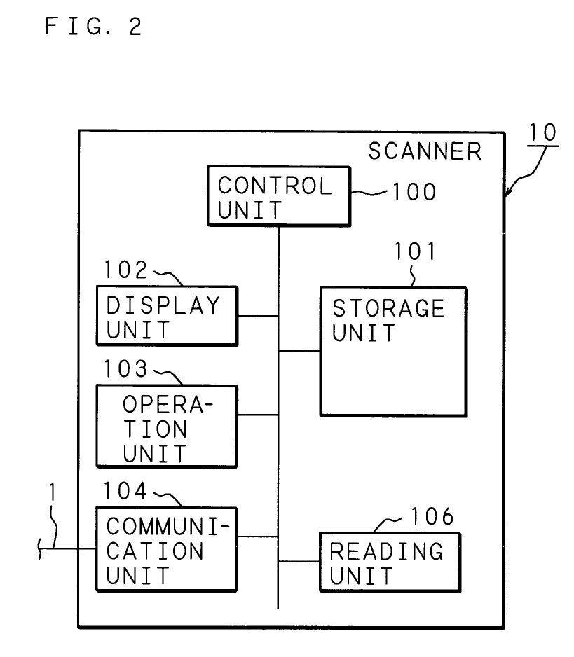

FIG. 2 is a block diagram of the scanner 10 as a component of the image information distributing system of Embodiment 1.

The reference numeral 100 in the figure denotes a control unit of the scanner 10. The control unit 100 is connected to components such as a storage unit 101 and a reading unit 106 via a bus. The control unit 100 controls the components in accordance with a program stored in the storage unit 101 using a ROM and executes various processings. A communication unit 104 is connected to the LAN 1 and the control unit 100 transmits/receives information via the LAN 1 and the communication unit 104.

The scanner 10 also has: a display unit 102 for displaying an operation state of the scanner 10 itself, an input instruction for the user, information received via the communication unit 104, and the like; and an operation unit 103 by which the user enters, while seeing the display unit 102, image information generating conditions (for example, resolution), the mail addresses of the information processing apparatus 30, 30, . . . to which a summary mail is to be sent, URL of a location in which image information is to be stored, an reading start instruction, and the like.

The reading unit 106 is controlled by the control unit 100 and is constructed so that reflected light of light emitted from a not-shown light source to an original is received by a CCD, an image of the original is converted into an electric signal, and image information according to the generating conditions is generated.

When the user sets an original in the scanner 10 and enters a mail address, URL, and the reading start instruction by operating the operation unit 103, the control unit 100 makes the reading unit 106 read an image of the original and generates image information. After that, the control unit 100 transmits the generated image information, and entered mail address and URL to the server 20 via the communication unit 104.

The image information may be image data obtained by reading an image formed in an original by the scanner 10 and converting the image into an electric signal, or character data obtained by converting the image data by using character recognizing means (for example, OCR).

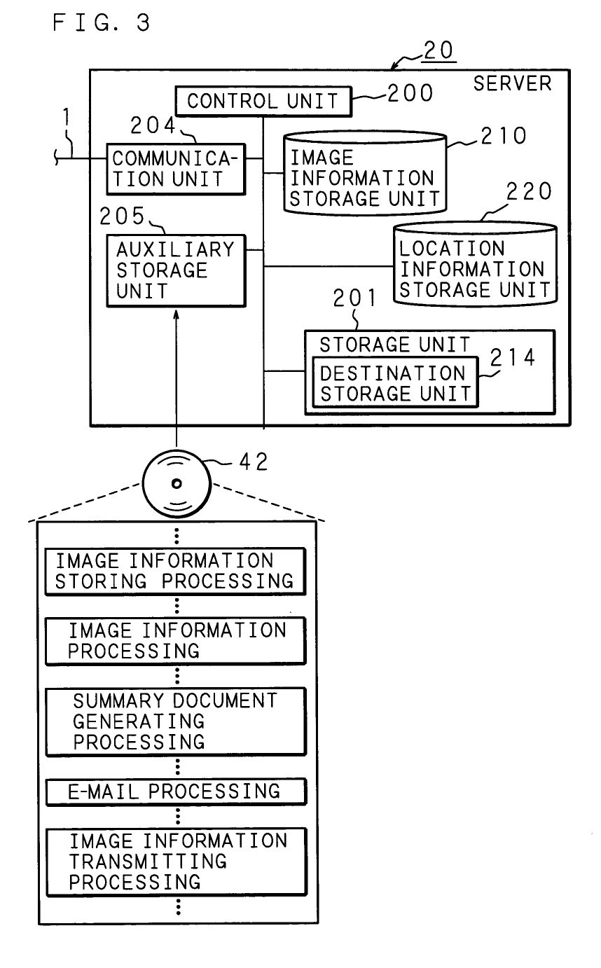

FIG. 3 is a block diagram of the server 20 as a component of the image information distributing system of Embodiment 1.

The reference numeral 200 in the figure denotes a control unit of the server 20. The control unit 200 is connected to components such as a storage unit 201 and an auxiliary storage unit 205 via a bus. The control unit 200 controls components in accordance with a program stored in the storage unit 201 using a hard disk or a not-shown ROM and executes various processings. As the auxiliary storage unit 205, for example, a CD-ROM drive can be used. Under control of the control unit 200, the auxiliary storage unit 205 reads information from a removable recording medium (for example, a computer memory product 42 in which a program according to Embodiment 1 is recorded) and stores it into the storage unit 201.

A communication unit 204 is connected to the LAN 1. The control unit 200 transmits/receives information via the LAN 1 and the communication unit 204.

The server 20 comprises an image information storage unit 210 for storing image information and a location information storage unit 220 for storing a correspondence relation between URL and image information. In a part of a storage area of the storage unit 201, a destination storage unit 214 for storing a mail address is allocated. When the mail address, image information, and URL are received via the communication unit 204, in accordance with an image information storing procedure of a program read from the computer memory product 42, the control unit 200 stores the received image information into the location in the image information storage unit 210, indicated by the received URL, stores the correspondence relation between the received image information and the received URL into the location information storage unit 220, and stores the received mail address into the destination storage unit 214.

The control unit 200 temporarily stores the received image information and the received URL into a not-shown RAM. The control unit 200 generates a summary image information by, for example, reducing the image information stored in the RAM by using a known technique (concretely, by decreasing an information amount by a process of thinning out the number of dots or the like). Subsequently, the control unit 200 generates a summary document including one set or a plurality of sets of the summary image information generated by the image information processing procedure and the URL stored in the RAM in accordance with a summary document generating procedure of the program.

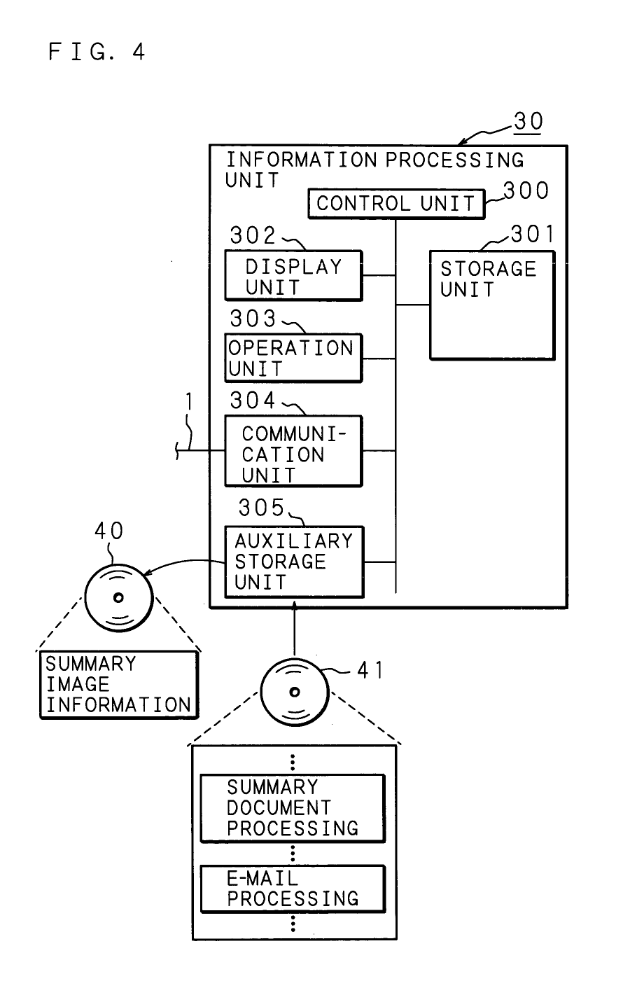

The summary document is so constructed that one or plurality of summary image information included in the summary document is displayed on a display unit 302 (see FIG. 4) by the information processing apparatus 30 in accordance with a summary document processing procedure which will be described later, and a receiving instruction button is provided in correspondence with each of the summary image information. Further, the summary document is so constructed that, when the receiving instruction button is operated, a transmitting instruction including the URL paired with the summary image information corresponding to the operated receiving instruction button is transmitted to the server 20 via the LAN 1. The summary document is generated so that its file size is smaller than the file size of the image information.

According to an E-mail processing procedure in the program, the control unit 200 generates a summary mail and transmits the generated summary mail to the information processing apparatuss 30, 30, . . . each having the mail address stored in the destination storage unit 214 via the communication unit 204.

When the transmitting instruction including the URL is received via the communication unit 204, according to an image information transmitting procedure of the program, the control unit 200 refers to the location information storage unit 220 and acquires image information stored in the location indicated by the URL of the image information storage unit 210 from the image information storage unit 210. Subsequently, the control unit 200 transmits via the communication unit 204 the acquired image information to the information processing apparatus 30 which has sent the transmitting instruction by using a communication protocol such as FTP (File Transfer Protocol) or HTTP (Hyper Text Transfer Protocol).

A summary document may be constructed by a set of one URL and a plurality of pieces of summary image information generated from each of a plurality of pieces of image information stored in the location indicated by the URL. In this case, on reception of a transmitting instruction including the URL, the plurality of pieces of image information are transmitted from the server 20 to the information processing apparatus 30 which has sent the transmitting instruction.

In the case where a plurality of receiving instruction buttons are operated, a summary document may be constructed so as to transmit a transmitting instruction including the URLs paired with the summary image information corresponding to each receiving instruction buttons to the server 20 via the LAN 1. In this case, the transmitting instruction is constructed by a plurality of URLs, and a plurality of pieces of image information corresponding to each of the plurality of URL are sent from the server 20 to the information processing apparatus 30 which has sent the transmitting instruction.

FIG. 4 is a block diagram of the information processing apparatus 30 as a component of the image information distributing system of Embodiment 1.

The reference numeral 300 in the figure denotes a control unit of the information processing apparatus 30. The control unit 300 is connected to components such as a storage unit 301, a display unit 302, an operation unit 303, and the like via a bus. The control unit 300 controls the components in accordance with a program stored in the storage unit 301 using a hard disk or a not-shown ROM and executes various processings. As an auxiliary storage unit 305, for example, a CD-ROM drive can be used. Under control of the control unit 300, the auxiliary storage unit 305 reads information from a removable recording medium (for example, the computer memory product 41 on which a program according to Embodiment 1 is recorded) and stores the read information into the storage unit 301 or writes information (for example, summary image information) to a removable recording medium 40 on which no information is recorded.

The information processing apparatus 30 has the display unit 302 using a CRT, a liquid crystal display or the like and the operation unit 303 using a mouse, a keyboard and the like.

A communication unit 304 is connected to the LAN 1 and, the control unit 300 transmits/receives information via the LAN 1 and the communication unit 304.

When an E-mail (in this case, summary mail) is received via the communication unit 304, the control unit 300 displays the contents of the summary mail on the display unit 302 or obtains attached information (in this case, the summary document) in accordance with an E-mail processing procedure of a known program or an E-mail processing procedure of the program read from the computer memory product 41.

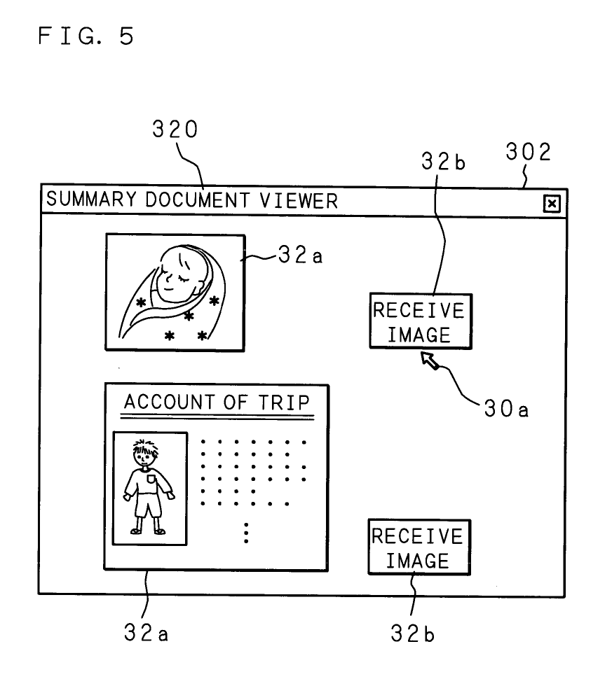

When the information acquired by the E-mail processing procedure is the summary document, the control unit 300 displays the one or plurality of pieces of summary image information included in the summary document onto the display unit 302 (see FIG. 5) in accordance with the summary document processing procedure of the program.

In the case of downloading image information via the communication unit 304 in accordance with the communication protocol such as FTP or HTTP, the control unit 300 displays image information on the display unit 302 in accordance with an image information displaying procedure of a known program stored in the storage unit 301 in response to the instruction of the user.

FIG. 5 is a schematic diagram showing an example of the summary image information displayed on the display unit 302 of the information processing apparatus 30 of Embodiment 1. On the display unit 302, a mouse pointer 30a which can be operated with a mouse of the operation unit 303 is displayed.

The control unit 300 displays a summary document viewer 320 on the display unit 302 in accordance with the summary document processing procedure. In the summary document viewer 320, summary image information 32a, 32a, . . . and receiving instruction buttons 32b, 32b, . . . corresponding to each summary image information 32a, 32a, . . . are displayed.

The user views the summary image information 32a, 32a, and determines whether image information (original image information) corresponding to the summary image information 32a, 32a, . . . is necessary or not. When it is necessary, the user operates the operation unit 303 to operate the mouse pointer 30a and performs a clicking operation on the required receiving instruction button 32b, thereby operating the receiving instruction button 32b. According to this operation, a receiving instruction is inputted to the information processing apparatus 30.

In the case where the receiving instruction is inputted, the control unit 300 sends the transmitting instruction including the URL paired with the summary image information corresponding to the operated receiving instruction button 32b to the server 20 via the communication unit 304.

Alternately, one receiving instruction button 32b may be provided for the plurality of pieces of summary image information 32a, 32a, . . . . In this case, when the receiving instruction button 32b is operated, a plurality of pieces of image information corresponding to the plurality of pieces of summary image 32a, 32a, . . . are transmitted from the server 20 to the information processing apparatus 30.

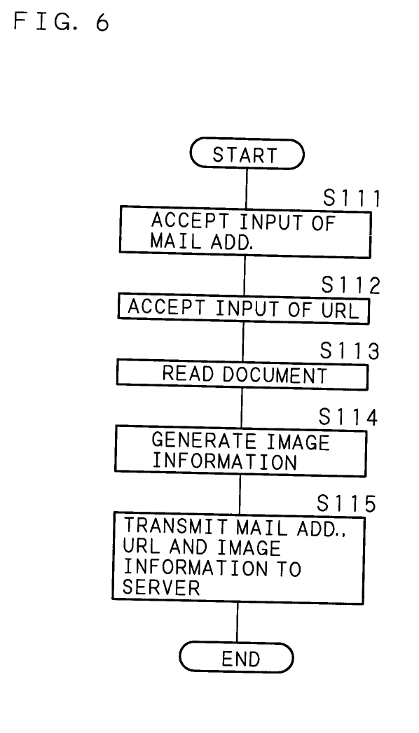

FIG. 6 is a flowchart showing an image information transmitting procedure of the scanner 10 of Embodiment 1.

The control unit 100 receives input of a mail address. In this case, by displaying a predetermined image on the display unit 102, the control unit 100 instructs the user to input the mail addresses of the information processing apparatuss 30, 30, . . . to which the summary mail is to be transmitted by using the operation unit 103 (step S111).

When the mail address is inputted, the control unit 100 accepts input of the URL. In this case, the control unit 100 makes the display unit 102 perform predetermined display, thereby instructing the user to input the URL of the location in which the image information is to be stored by using the operation unit 103 (step S112).

When the URL is inputted, the control unit 100 makes the reading unit 106 read an image of the original in response to input of the reading start instruction from the operation unit 103 (step S113), and generates image information (step S114).

Finally, the control unit 100 transmits the mail address inputted in step S111, the URL inputted in step S112, and the image information generated in step S114 to the server 20 (step S115) and terminates an image information transmitting procedure.

In the case of accepting the input instructions of the mail address and the URL in steps S111 and S112, it is also possible to perform communication between the scanner 10 and the server 20, display onto the display unit 102 of the scanner 10 one or a plurality of mail addresses preliminarily registered in the server 20 and one or a plurality of URLs each indicative of the location in the image information storage unit 210 in which image information can be stored, and allow the user to select required mail address and URL from the displayed mail addresses and URLs by using the operation unit 103.

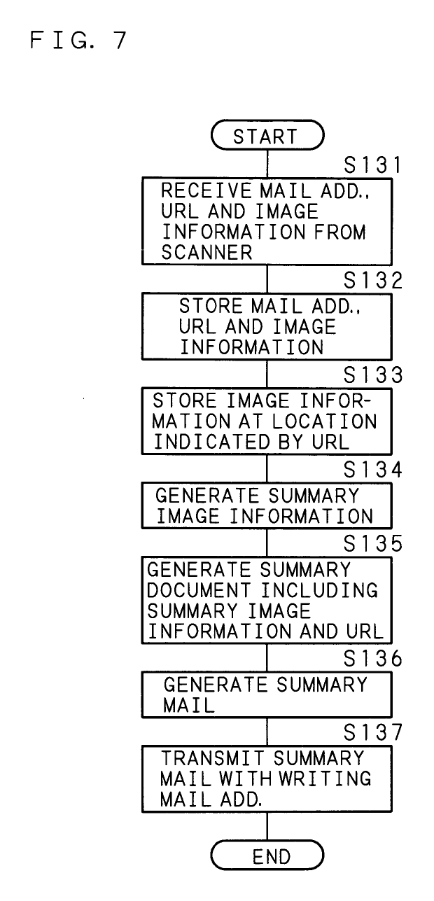

FIG. 7 is a flowchart showing a summary mail transmitting procedure of the server 20 of Embodiment 1.

When the mail address, URL, and image information are received from the scanner 10 (step S131), the control unit 200 stores the image information and URL into the RAM and stores the mail address into the destination storage unit 214 (step S132). Further, the control unit 200 stores the image information stored in the RAM in the location in the image information storage unit 210 indicated by the URL stored in the RAM and stores the correspondence relation between the image information and the URL into the location information storage unit 220 (step S133).

Subsequently, the control unit 200 reduces the image information stored in the RAM to generate summary image information (step S134) and generates a summary document including a set of the generated summary image information and the URL stored in the RAM (step S135).

Finally, the control unit 200 generates an E-mail (summary mail) (step S136) to which the summary document generated in step S135 is attached, writes the mail address stored in the destination storage unit 214 into the generated summary mail, transmits the summary mail via the communication unit 204 (step S137), and terminates the summary mail transmitting procedure.

In this case, the summary mail sent from the server 20 is received by information processing apparatus 30, 30, . . . having the mail address written in the summary mail.

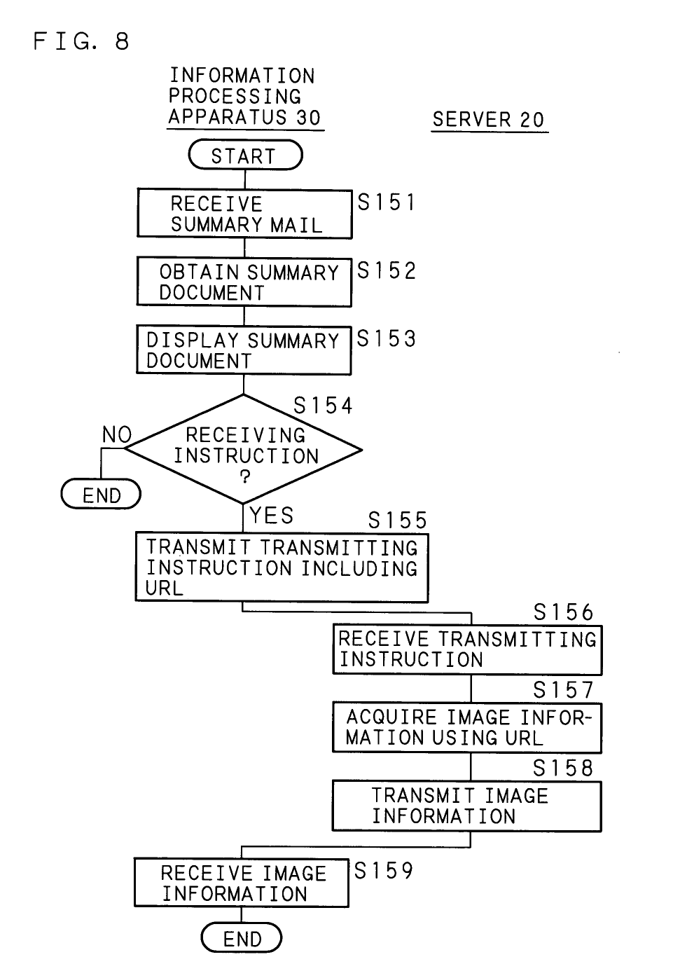

FIG. 8 is a flowchart showing the image information transmitting/receiving procedure of the information processing apparatus 30 and the server 20 of Embodiment 1.

When the summary mail is received via the communication unit 304 (step S151), the control unit 300 of the information processing apparatus 30 obtains the attached summary document in accordance with an input operation by the user with the operation unit 303 (step S152) and displays the summary image information 32a, 32a . . . included in the summary document and the receiving instruction buttons 32b, 32b, . . . on the display unit 302 (step S153). At this time, the control unit 300 accepts input of a receiving instruction which is done by the user's operation of the receiving instruction button 32b.

In this case, the user acquires the summary mail by, for example, a known mailer, opens the summary document as an attached file by using a program including the summary document processing procedure, and views the summary image information 32a, 32a, . . . . In the case where the user needs the image information corresponding to the summary image information 32a, the user operates the receiving instruction button 32b. Specifically, the user inputs the receiving instruction to the information processing apparatus 30.

The control unit 300 determines whether the receiving instruction is inputted or not (step S154). When it is not inputted (NO in step S154), the image information transmitting/receiving procedure is terminated.

In the case where the receiving instruction is inputted, that is, in the case where the receiving instruction button 32b is operated (YES in step S154), the control unit 300 transmits the transmitting instruction including the URL paired with the summary image information 32a corresponding to the operated receiving instruction button 32b to the server 20 via the communication unit 304 (step S155).

When the transmitting instruction is received (step S156), the control unit 200 of the server 20 refers to the location information storage unit 220 including the URL included in the received transmitting instruction and acquires the image information stored in the location in the image information storage unit 210 indicated by the URL (step S157). After that, the control unit 200 transmits the image information to the information processing apparatus 30 which has sent the transmitting instruction by using a communication protocol such as FTP or HTTP (step S158).

The information processing apparatus 30 receives the image information sent from the server 20 via the communication unit 304 (step S159) and terminates the image information transmitting/receiving procedure. In such a manner, the information processing apparatus 30 downloads required image information.

The image information distributing system as described above generates a summary mail by attaching to an E-mail a summary document including the summary image information 32a corresponding to image information stored in the server 20 and the URL of the corresponding image information and transmits the summary mail to the required information processing apparatuss 30, 30, . . . The user obtains the summary document attached to the summary mail by using the information processing apparatus 30 which has received the summary mail. At this time, the information amount of the summary document is smaller than that of image information. Consequently, also in the case of transmitting the summary mail to distribute image information to a number of information processing apparatuss 30, 30, . . . , as compared with the case of sending an E-mail to which image information itself is attached to the information processing apparatuss 30, 30, . . . , traffic of a transmission path can be decreased.

When new image information is inputted to the image information distributing system by the scanner 10, different from the case of transmitting an E-mail to which image information itself is attached, a summary mail is sent. Thus, image information unnecessary to the user can be prevented from being transmitted, and increase in traffic of the transmission path due to transmission of unnecessary image information can be prevented.

By transmitting a summary mail to the required information processing apparatuss 30, 30, . . . , the users of the information processing apparatuss 30, 30, . . . can be notified of the fact that new image information is stored in the server 20.

By viewing the summary image information 32a, 32a, . . . by using the information processing apparatus 30, the user can know the contents of image information stored in the server 20 and can easily determine whether image information is necessary or not. When the information processing apparatus 30 is the one which has directly received the summary mail, the convenience of the user can be improved and efficiency of image information distribution can be improved.

Since communication is not performed between the information processing apparatus 30 and the server 20, the scanner 10, or the like when the user views the summary image information 32a, 32a, . . . , traffic of a transmission path can be prevented from being increased.

When image information corresponding to the summary image information 32a is necessary, the user can acquire the image information by operating the receiving instruction button 32b. Therefore, it is unnecessary to input the URL and a spelling mistake at the time of inputting the URL does not occur, so that convenience of the user can be improved. Since the operation of the receiving instruction button 32b by the user is very easy, an input error can be prevented.

Since both of the summary image information 32a and the URL are integrally included in a summary document, the summary image information 32a and the URL corresponding to the summary image information 32a can be easily managed by using the information processing apparatus 30.

Since only necessary image information can be selectively downloaded by using the information processing apparatus 30, traffic of a transmission path can be decreased.

Further, as the scanner of the system, a known scanner can be used. Thus, the cost of the scanner can be prevented from increasing.

The server 20 can manage the image information and information such as the destination of a summary mail (mail address of the information processing apparatus 30 to which a summary mail has been sent) in a lump. Further, since only image information required by the user can be selectively transmitted, traffic of a transmission path can be decreased.

The information processing apparatus 30 which received the summary mail in step S151 may transmit the summary mail or summary document obtained in step S152 to another information processing apparatus 30, and write it into the removable recording medium 40 by the auxiliary storage unit 305, or record it onto a recording medium such as a flexible disk or a hard disk of a file server. In this case, by using the information processing apparatus 30 other than information processing apparatus 30 which has received the summary mail directly from the image information distributing system (the server 20 in Embodiment 1), the summary mail or summary document can be obtained. In such a case, when the information processing apparatus 30 which has obtained the summary mail or summary document is connected to the LAN 1, the user can make the information processing apparatus 30 receive image information. Even when the information processing apparatus 30 is not connected to the LAN 1, the user can view the summary image information 32a, 32a, . . . .

Although image information is stored in the location indicated by the URL inputted or selected by the user in Embodiment 1, for example, the server 20 may automatically determine the location in which image information is to be stored. In this case, the server 20 generates the URL corresponding to the location in which image information is to be stored.

In Embodiment 1, although the summary mail is transmitted to the information processing apparatuss 30, 30, . . . having the mail address inputted/selected by the user, for example, it is also possible to provide the server 20 with a registering unit for registering a required mail address and automatically transmit the summary mail to the information processing apparatuss 30, 30, . . . having the mail address registered in the registering unit.

It is sufficient that the contents of original image information can be associated from the summary image information, and the information amount of the summary image information is smaller than that of original image information. For example, a part of original image information, information obtained by compressing original image information, information obtained by decreasing resolution, the number of colors, or the like of original image information, information obtained by re-editing original image information so as to be summarized, or the like can be used as summary image information.

Further, the server 20 does not transmit image information itself to the information processing apparatus 30 which has sent a transmitting instruction but may transmit an E-mail to which image information to be transmitted is attached as an attached file.

Embodiment 2

An image information distributing system of Embodiment 2 is constructed by connecting to a LAN 1 the scanner 10, the server 20, and the information processing apparatuss 30, 30, . . . corresponding to the information processing apparatuss 30, 30, . . . constructing the image information distributing system of Embodiment 1.

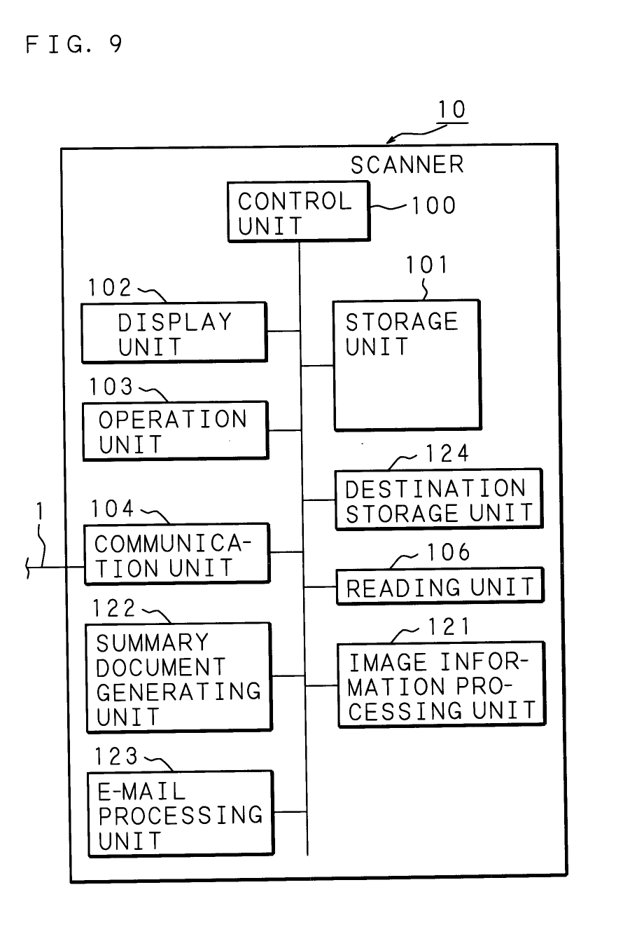

FIG. 9 is a block diagram of a scanner 10 as a component of an image information distributing system according to Embodiment 2.

The reference numeral 124 in the figure denotes a destination storage unit of the scanner 10. The destination storage unit 124 stores a mail address. As the destination storage unit 124, non-volatile storing means such as a hard disk is used.

When the user sets an original in the scanner 10 and inputs a mail address, URL, and a read start instruction by operating the operation unit 103, the control unit 100 makes the reading unit 106 read an image of an original and generates image information. Subsequently, the control unit 100 stores the generated image information and the inputted URL into, for example, a not-shown RAM and, further, transmits the generated image information and the inputted URL to the server 20 via the communication unit 104.

The scanner 10 comprises an image information processing apparatus 121 which is controlled by the control unit 100 and generates summary image information by reducing the image information stored in the RAM by using a known technique. The scanner 10 also comprises a summary document generating unit 122 which is controlled by the control unit 100 and generates a summary document including one or a plurality of sets each consisting of the generated summary image information and the URL stored in the RAM. The scanner 10 also has an E-mail processing unit 123 which is controlled by the control unit 100, generates a summary mail and transmits the generated summary mail to the information processing apparatuss 30, 30, . . . each having a mail address stored in the destination storage unit 124 via the communication unit 104.

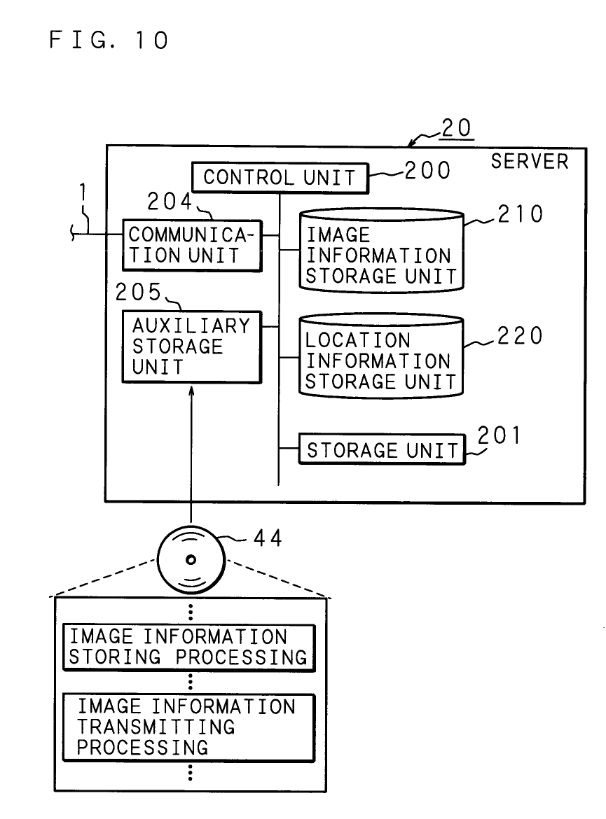

FIG. 10 is a block diagram of a server 20 as a component of the image information distributing system according to Embodiment 2.

The reference numeral 205 in the figure denotes an auxiliary storage unit of the server 20. As the auxiliary storage unit 205, for example, a CD-ROM drive can be used. Under control of a control unit 200, the auxiliary storage unit 205 reads information from a removable recording medium (for example, a recording medium 44 on which a program according to Embodiment 2 is recorded) and stores it into the storage unit 201.

When a transmitting instruction including URL is received via the communication unit 204, in accordance with an image information transmitting procedure of a program read from the computer memory product 44, with reference to the location information storage unit 220, the control unit 200 acquires image information stored in the location of the image information storage unit 210 indicated by the received URL from the image information storage unit 210. After that, the control unit 200 transmits the acquired image information to the information processing apparatus 30 which has sent the transmitting instruction via the communication unit 204 by using a communication protocol such as FTP or HTTP.

The other parts corresponding to those in Embodiment 1 are designated with the same reference numerals and their description will not be repeated.

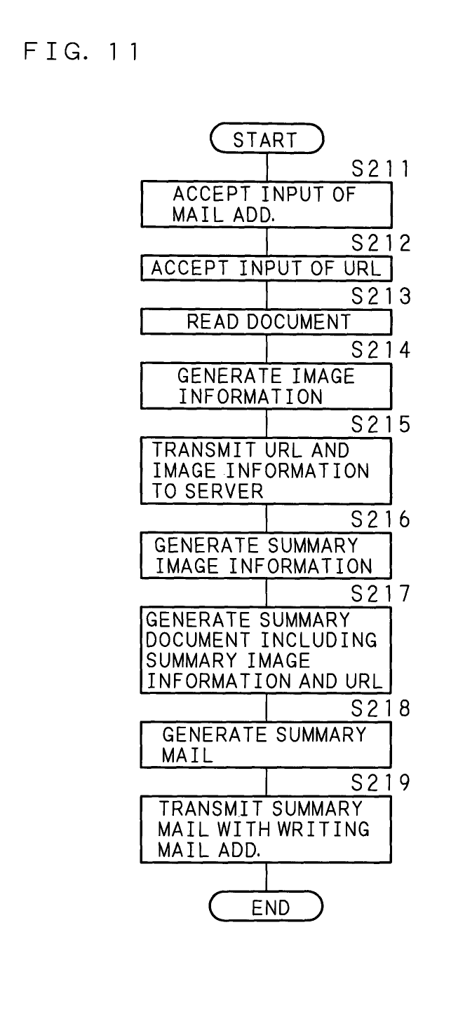

FIG. 11 is a flowchart showing a summary mail transmitting procedure of the scanner 10 of Embodiment 2.

The control unit 100 accepts input of a mail address. In this case, by making the display unit 102 perform predetermined display, the control unit 100 instructs the user to input the mail addresses of the information processing apparatuss 30, 30, . . . to which the summary mail is to be transmitted by using the operation unit 103 (step S211). When the mail address is inputted, the control unit 100 stores the inputted mail address into the destination storage unit 124.

After that, the control unit 100 accepts input of the URL. In this case, the control unit 100 allows a predetermined image to be displayed on the display unit 102, thereby instructing the user to input the URL of the location in which the image information is to be stored by using the operation unit 103 (step S212). In the case where the URL is inputted, the control unit 100 stores the inputted URL into the RAM.

When a reading start instruction is inputted from the operation unit 103, the control unit 100 makes the reading unit 106 read an image in an original (step S213) and generates image information (step S214).

Subsequently, the control unit 100 transmits the URL inputted in step S212 and the image information generated in step S214 to the server 20 (step S215).

The control unit 100 makes the image information processing apparatus 121 reduce the image information generated in step S214 to generate summary image information (step S216) and makes the summary document generating unit 122 generate a summary document including the set of the generated summary image information and the URL stored in the RAM (step S217).

Finally, the control unit 100 makes the E-mail processing unit 123 generate an E-mail (summary mail) to which the generated summary document is attached as an attached file (step S218), writes the mail address stored in the destination storage unit 124 into the generated summary mail, transmits the summary mail via the communication unit 104 (step S219), and terminates the summary mail transmitting procedure.

In this case, the summary mail transmitted from the scanner 10 is received by the information processing apparatuss 30, 30, . . . having the mail address written in the summary mail.

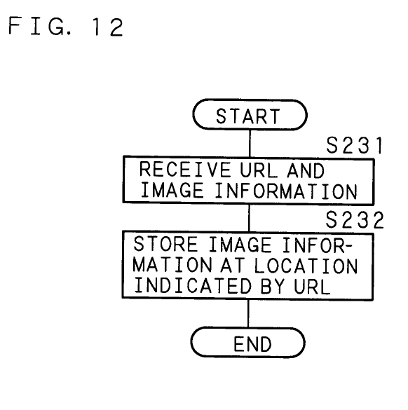

FIG. 12 is a flowchart showing an image information storing procedure of the server 20 of Embodiment 2.

When the URL and image information are received (step S231), the control unit 200 stores the received image information into the location in the image information storing unit 210 indicated by the received URL in accordance with the image information storing procedure of the program read from the computer memory product 44, stores the correspondence relation between the image information and the URL in the location information storing unit 220 (step S232), and terminates the image information storing procedure.

The image information transmitting/receiving procedure of the information processing apparatus 30 and the server 20 of Embodiment 2 is similar to that of Embodiment 1 (see FIG. 8).

The image information distributing system can obtain effects similar to those of the image information distributing system of Embodiment 1.

Since the processings such as generation of the summary document and transmission of a summary mail can be performed by, generally, the scanner 10 having a longer wait state as compared with the server 20 or the information processing apparatus 30 during the wait state, the period of the wait state of the scanner 10 can be efficiently used. Since the process efficiency of the whole image information distributing system is improved, efficiency of image information distribution can be improved.

Embodiment 3

An image information distributing system of Embodiment 3 is constructed by connecting to the LAN 1 the scanner 10, a server 20 corresponding to the server 20 as a component of the image information distributing system of Embodiment 2 (see FIG. 10), and the information processing apparatuss 30, 30, . . .

When URL and image information are received from the information processing apparatus 30, the server 20 of Embodiment 3 stores the received image information in the location in the image information storing unit 210 indicated by the received URL and stores the correspondence relation between the image information and the URL into the location information storing unit 220.

The scanner 10 of Embodiment 3 has components similar to those of the scanner 10 as a component of the image information distributing system of Embodiment 1 (see FIG. 2) and, further, receives image information generating conditions, reading start instruction, and the like from the information processing apparatus 30 via the communication unit 104.

When the user sets an original in the scanner 10 and receives the image information generating conditions and reading start instruction, the control unit 100 makes the reading unit 106 read an image of the original and generates image information according to the received generation conditions. Subsequently, the control unit 100 transmits the generated image information to the information processing apparatus 30 which has sent the reading start instruction received before via the communication unit 104.

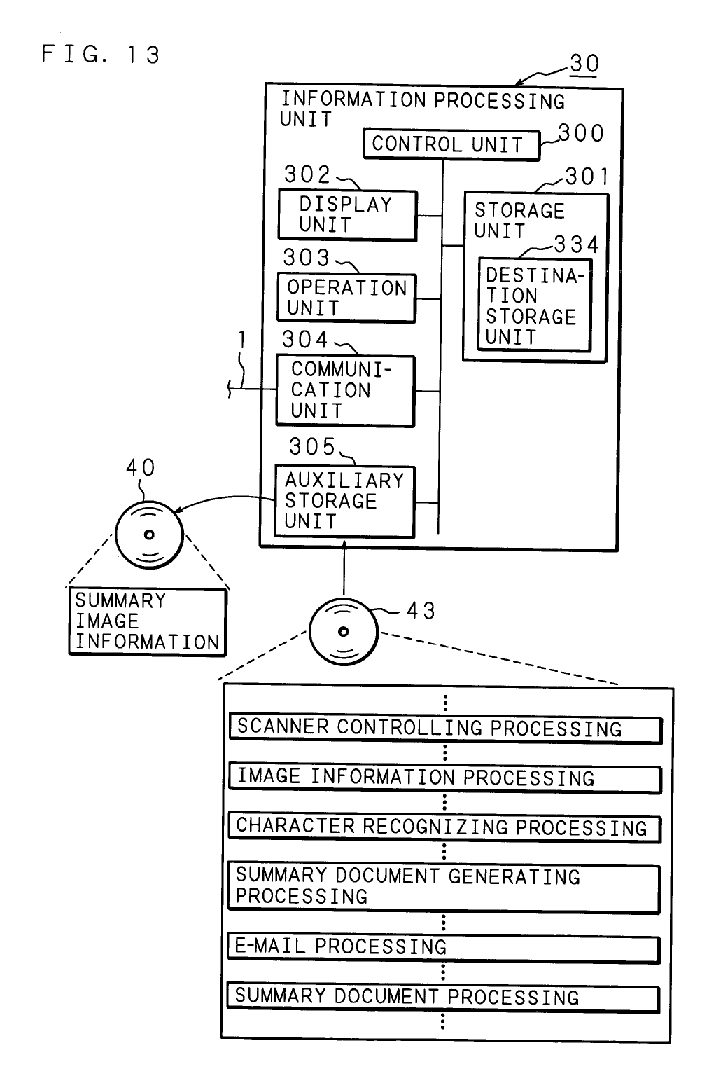

FIG. 13 is a block diagram of the information processing apparatus 30 as a component of Embodiment 3 of the image information distributing system according to the present invention.

The reference numeral 305 in the figure denotes an auxiliary storage unit of the information processing apparatus 30. As the auxiliary storage unit 305, for example, a CD-ROM drive can be used. The auxiliary storage unit 305 is controlled by the control unit 300, reads information from a removable recording medium (for example, a recording medium 43 in which a program according to Embodiment 3 is recorded), stores it into the storage unit 301, and writes the summary image information into a removable recording medium 40.

According to a scanner control procedure of the program read from recording medium 43, the control unit 300 controls the display unit 302 to instruct the user to input the mail address of the information processing apparatuss 30, 30, . . . to which the summary mail is to be transmitted, the URL of the location in which image information is to be stored, image information generating conditions, reading start instruction, and the like by using the operation unit 303. When character information as a keyword is included in the image information, the control unit 300 also instructs to input a keyword extracting instruction.

When the mail address, URL, image information generating conditions, and reading start instruction are inputted, the control unit 300 transmits the inputted image information generating conditions and reading start instruction to the scanner 10 via the communication unit 304.

A part of a storage area of the storage unit 301 is allocated as a destination storage unit 334 for storing a mail address. When the mail address and URL are inputted from the operation unit 303, the control unit 300 stores the inputted image mail address into the destination storage unit 334 and stores the inputted URL into a not-shown RAM. When image information is received via the communication unit 304, the control unit 300 stores the received image information into the RAM and the storage unit 301. Further, the control unit 300 transmits the received image information and the URL to the server 20 via the communication unit 304.

The control unit 300 generates summary image information by reducing the image information stored in the RAM by using a known technique in accordance with the image information processing procedure of the program. When a keyword extracting instruction is inputted from the operation unit 303, the control unit 300 performs character recognition by using the image information stored in the RAM in accordance with a character recognizing procedure of the program and generates a keyword. The control unit 300 generates a summary document including one or a plurality of sets of the summary image information generated by the image information processing procedure, the keyword of the summary image information, and the URL stored in the RAM in accordance with the summary document generating procedure in the program.

The summary document is so constructed that, when the keyword of the summary image information is included in the summary document, the keyword is also displayed in the summary document.

According to the E-mail processing procedure of the program, the control unit 300 generates a summary mail to which the summary document generated in the summary document generating procedure is attached as an attached file and transmits the generated summary mail to the information processing apparatuss 30, 30, . . . having the mail address stored in the destination storage unit 334 via the communication unit 304. When the summary mail is received via the communication unit 304, the control unit 300 displays the contents of the summary mail on the display unit 302 or obtains the attached summary document in accordance with the E-mail processing procedure.

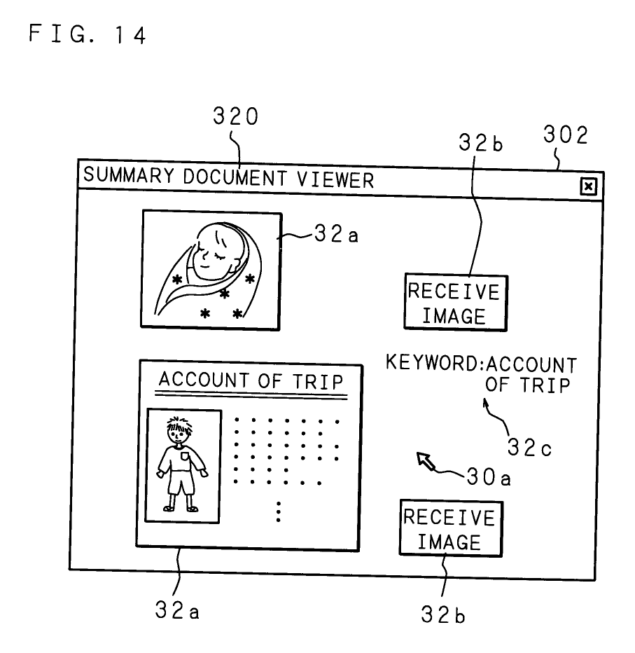

When the obtained information is a summary document, according to the summary document processing procedure of the program, the control unit 300 displays onto the display unit 302 (see FIG. 14) the one or plurality of summary image information and/or the keyword of the summary image information included in the received summary document.

FIG. 14 is a schematic diagram showing an example of summary image information displayed on the display unit 302 of the information processing apparatus 30 of Embodiment 3.

The control unit 300 displays a summary document viewer 320 in the display unit 302 in accordance with a summary document processing procedure. In the summary document viewer 320, the summary image information 32a, 32a, . . . and the receiving instruction buttons 32b, 32b, . . . corresponding to each summary image information 32a, 32a, . . . are displayed. In the case where the keyword of the summary image information is included in the summary document, a keyword 32c of the summary image information 32a is also displayed in the location adjacent to the summary image information 32a.

The user views the summary image information 32a, 32a, and determines whether image information corresponding to the summary image information 32a, 32a, . . . is necessary or not. The user retrieves the keyword and determines whether the summary image information 32a, 32a, . . . corresponding to required image information exists or not.

When image information is necessary, the user operates the mouse pointer 30a by operating the operation unit 303 and performs click operation on the required receiving instruction button 32b, thereby operating the receiving instruction button 32b. In response to the operation, a receiving instruction is inputted to the information processing apparatus 30.

In the case where the receiving instruction is inputted, the control unit 300 transmits a transmitting instruction including the URL paired with the summary image information 32a corresponding to the operated receiving instruction button 32b to the server 20 via the communication unit 304.

Parts corresponding to those in Embodiments 1 and 2 are designated with the same reference numerals and their description will not be repeated.

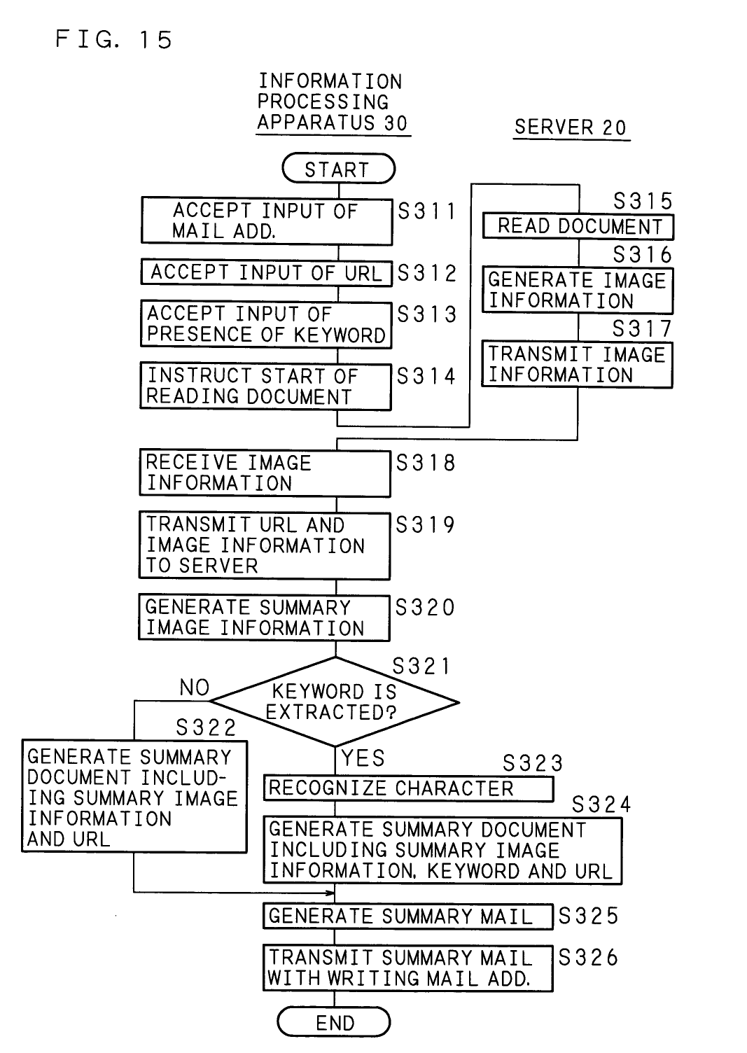

FIG. 15 is a flowchart showing a summary mail transmitting procedure of the information processing apparatus 30 and the scanner 10 as components of Embodiment 3 of the image information distributing system of the present invention.

The control unit 300 of the information processing apparatus 30 accepts input of the mail address. In this case, the control unit 300 makes the display unit 302 perform predetermined display, thereby instructing the user to input the mail address of the information processing apparatuss 30, 30, . . . to which the summary mail is transmitted by using the operation unit 303 (step S311). In the case where a mail address is inputted, the control unit 100 stores the inputted mail address into the destination storage unit 334.

Subsequently, the control unit 300 accepts input of the URL. In this case, the control unit 300 makes the display unit 302 perform predetermined display, thereby instructing the user to input the URL of the location in which image information is to be stored by using the operation unit 303 (step S312). In the case where the URL is inputted, the control unit 300 stores the inputted URL into the RAM.

After that, the control unit 300 accepts an input indicative of whether character information as a keyword is included in an image of an original to be read. In this case, the control unit 300 makes the display unit 302 perform predetermined display, thereby instructing the user to input a keyword extracting instruction by using the operation unit 303 when a keyword is included (step S313).

When the reading start instruction is inputted from the operation unit 303, the control unit 300 transmits the inputted reading start instruction to the scanner 10 via the communication unit 304 (step S314).

When the reading start instruction is received via the communication unit 104, the control unit 100 of the scanner 10 makes the reading unit 106 read the image of the original (step S315) and generates image information (step S316). Subsequently, the control unit 100 transmits the image information generated in step S316 to the information processing apparatus 30 which has sent the reading start instruction (step S317).

In the case where image information is received via the communication unit 304 (step S318), the control unit 300 of the information processing apparatus 30 stores the received image information into the RAM. After that, the control unit 300 transmits the image information received in step S318 and the URL inputted in step S312 to the server 20 (step S319).

Subsequently, the control unit 300 reduces the image information stored in the RAM, thereby generating summary image information (step S320).

Further, by determining whether the keyword extracting instruction is inputted in step S313 or not, the control unit 300 determines whether character information is included in the received image information or not (step S321). When the keyword extracting instruction is not inputted (NO in step S321), the control unit 300 determines that no character information is included in the received image information and generates a summary document including the set of the generated summary image information and the URL stored in the RAM (step S322).

In the case where the keyword extracting instruction is inputted (YES in step S321), the control unit 300 determines that character information is included in the received image information, performs character recognition, generates character information (step S323), and extracts a keyword from the generated character information. Subsequently, the control unit 300 generates a summary document including a set of the summary image information generated in step S320, the keyword extracted in step S323, and the URL stored in the RAM (step S324).

Finally, the control unit 300 generates an E-mail (summary mail) to which the summary document generated in step S322 or S324 as an attached file is attached (step S325), writes the mail address stored in the destination storage unit 334 into the generated summary mail, transmits the resultant via the communication unit 304 (step S326), and terminates the summary mail transmitting procedure.

In this case, the transmitted summary mail is received by the information processing apparatuss 30, 30, . . . having the mail address inputted in step S311. At this time, the information processing apparatus 30 which has sent the summary mail may receive the summary mail by itself.

The image information storing procedure of the server 20 of Embodiment 3 of the image information distributing system of the present invention is similar to that of Embodiment 2 (see FIG. 12) and the image information transmitting/receiving procedure of the information processing apparatus 30 and the server 20 is similar to that of Embodiment 1 (see FIG. 8). In this case, in step S153 of FIG. 8, the summary image information, keyword, and receiving instruction button included in the summary document are displayed on the display unit 302.

The image information distributing system of Embodiment 3 can obtain effects similar to those of the image information distributing system of Embodiment 1 or 2.

By viewing the summary image information 32a, 32a, . . . by using the information processing apparatus 30, the user can know the contents of the image information stored in the server 20 and easily determine whether the image information is necessary or not. By retrieving for image information necessary for the user with the keyword of the contents of the information, whether the summary image information 32a corresponding to the necessary image information is included in the summary document or not can be easily determined.

In the image information distributing system of Embodiment 3, generally, the processing of generating a summary document and transmitting a summary mail is performed by using the information processing apparatus 30 having the smaller number of image information distributing processings as compared with the server 20. Consequently, the information processing apparatus 30 can be used efficiently. Since the process efficiency of the image information distributing system as a whole is improved, efficiency of the image information distribution can be improved.

In the case where work or input of the user (such as inputting/selection of URL, mail address, or the like, or edition of the summary image information 32a or keyword) is necessary in the image information distributing process, since the information processing apparatus 30 has the display unit 302 and the operation unit 303 which are generally bigger and more easily used than the display unit 102 and the operation unit 103 of the scanner 10, convenience of the user can be improved.

The user who performed reading of an original with the scanner 10 can manage image information and information such as the destination of a summary mail in a lump by using the information processing apparatus 30.

Further, a known scanner can be used as the scanner as a component of the system, so that an increase in cost of the scanner can be prevented.

In the case of performing character recognition in step S323 in FIG. 15 and extracting a keyword, the user may select one or a plurality of character information in the character information recognized by using the image information. Further, the information processing apparatus 30 may automatically select predetermined character information (character information as a keyword indicative of the contents of the image information) in the character information.

The scanner 10 obtains the URL from the information processing apparatus 30 or by the scanner 10 itself and transmits the obtained URL and the generated image information to the server 20. In the case where the scanner 10 obtains the URL by itself, not only the image information but also the URL may be transmitted to the information processing apparatus 30.

Although each of the image information distributing systems of Embodiments 1 to 3 is constructed by using the scanner, an image information distributing system can be also constructed by using a copying machine, a facsimile apparatus, a combined apparatus or the like in each of which the scanner is assembled.

The image information distributing system can be also constructed by using an apparatus in which a scanner and a server are integrally constructed (for example, a scanner, a copying machine, a facsimile apparatus, a combined apparatus, or the like each having a server function, an image information storage unit, and the like).

As described above in detail, according to the image information distributing method and the image information distributing system of the present invention, image information is stored in a central apparatus, and summary image information whose information amount is smaller is generated by using the image information. When character information is included in the image information, the character information is recognized and an E-mail obtained by attaching a summary document including summary image information and/or character information and location information of image information as an attached file is transmitted to one or a plurality of terminal apparatus. With the configuration, as compared with the conventional case of transmitting an E-mail to which image information itself is attached to a terminal apparatus, increase in traffic of a transmission path by transmission of image information unnecessary for the user can be prevented.

The user can view the summary image information and/or character information by using a terminal apparatus having a summary document. Therefore, the user can know the contents of the image information stored in the central apparatus and easily determine whether the image information is necessary or not. In this case, it is unnecessary to perform communication between the terminal apparatus and the other apparatus, so that traffic of the transmission path can be prevented from increasing. Since both of summary image information and location information is integrally included in a summary document, the summary image information and the location information corresponding to the summary image information can be easily managed by using the terminal apparatus.

In the case where the image information corresponding to the summary image information is necessary, the user can acquire the image information by inputting a receiving instruction by using a terminal apparatus having a summary document. Thus, it is unnecessary to input location information and convenience of the user can be improved. By providing means for accepting input of a receiving instruction as means which can be easily operated and by which the user can easily input an instruction, an input error can be prevented. Further, the user can selectively receive only necessary image information by using a terminal apparatus, so that traffic of a transmission path can be decreased.

Since the central apparatus of the present invention and the computer memory product on which a computer program for making a general purpose computer function as a central apparatus can construct the image information distributing system, traffic of a transmission path is decreased, efficiency of image information distribution is improved, and convenience of the user can be improved.

Since the terminal apparatus of the present invention and the computer memory product on which a computer program for making a general purpose computer function as a terminal apparatus can construct the image information distributing system, traffic of a transmission path is decreased, efficiency of image information distribution is improved, and convenience of the user can be improved. Also in a terminal apparatus which is not a component of the image information distributing system, its user can view summary image information and/or character information. Thus, such user can know the contents of the image information stored in the central apparatus and easily determine whether the image information is necessary or not.

Since the scanner apparatus of the present invention can be used as a component of the image information distributing system, traffic of a transmission path is decreased, efficiency of image information distribution is improved, and convenience of the user can be improved.

As described above, the present invention provides excellent effects.

As this invention may be embodied in several forms without departing from the spirit of essential characteristics thereof, the present embodiments are therefore illustrative and not restrictive, since the scope of the present invention is defined by the appended claims rather than by the description preceding them, and all changes that fall within metes and bounds of the claims, or equivalence of such metes and bounds there-of are therefore intended to be embraced by the claims.

1. An image information distributing method for receiving image information stored in a central apparatus by one or a plurality of terminal apparatus, comprising the steps of:
generating, by using said image information stored in said central apparatus, summary image information whose information amount is smaller than said image information;
generating a summary document including location information indicative of a location in which said image information is stored and said summary image information;
generating a summary E-mail by attaching said generated summary document to an E-mail; and
transmitting said generated summary E-mail to said one or a plurality of terminal apparatus.

2. The image information distributing method as set forth in claim 1, further comprising the steps of:
determining whether character information is included in said image information or not; and
in the case where character information is included in said image information, making said character information to be included in said summary document.

3. The image information distributing method as set forth in claim 2, wherein said terminal apparatus comprises displaying means, the summary image information and/or character information included in the received summary document is displayed on said displaying means.

4. The image information distributing method as set forth in claim 3, wherein
said terminal apparatus accepts input of a receiving instruction for requesting reception of image information corresponding to the received summary image information and/or character information, and, when said receiving instruction is inputted, in response to the summary image information and/or character information corresponding to the image information requested to be received, transmits to said central apparatus a transmitting instruction including the location information included in the received summary document, and
said central apparatus, when the transmitting instruction is received, transmits image information stored in a location indicated by the location information included in the received transmitting instruction to the terminal apparatus which has transmitted the received transmitting instruction.

5. An image information distributing system in which a scanner apparatus for generating image information by reading an image of an original and transmitting said image information, a central apparatus for receiving and storing the image information transmitted from said scanner apparatus, and one or a plurality of terminal apparatus for receiving the image information transmitted from said central apparatus are connected via communicating means,
wherein any of said scanner apparatus, said central apparatus and said terminal apparatus comprises:
summary document generating means having means for generating, by using said image information generated by said scanner apparatus, summary image information whose information amount is smaller than said image information, and means for generating a summary document including location information indicative of a location in which said image information generated by said scanner apparatus is stored and said summary image information; and
E-mail processing means having means for generating a summary E-mail by attaching said generated summary document to an E-mail, and means for transmitting the generated summary E-mail to said terminal apparatus.

6. The image information distributing system as set forth in claim 5, wherein said summary document generating means comprises:
means for determining whether character information is included in said image information or not; and
means, in the case where character information is included in said image information, for making said character information to be included in said summary document.

7. The image information distributing system as set forth in claim 6, wherein
said terminal apparatus comprises displaying means, and
said summary document processing means is provided on said terminal apparatus and displays summary image information and/or character information included in the summary document onto said displaying means.

8. The image information distributing system as set forth in claim 7, wherein
said summary document processing means comprises: means for accepting input of a receiving instruction for requesting reception of image information corresponding to said summary image information and/or character information; and means for, when said receiving instruction is inputted, in response to the summary image information and/or character information corresponding to the image information requested to be received, transmitting to said central apparatus a transmitting instruction including the location information included in the received summary document, and
said central apparatus comprises means for, when the transmitting instruction is received, transmitting image information stored in a location indicated by the location information included in the received transmitting instruction to the terminal apparatus which has transmitted the received transmitting instruction.

9. The image information distributing system as set forth in claim 8, wherein said summary document generating means and said E-mail processing means are provided on said central apparatus.

10. The image information distributing system as set forth in claim 8, wherein said summary document generating means and said E-mail processing means are provided on said scanner apparatus.

11. The image information distributing system as set forth in claim 8, wherein
said scanner apparatus comprises means for transmitting said image information to a predetermined terminal apparatus,
said summary document generating means and said E-mail processing means are provided on said predetermined terminal apparatus, and
said predetermined terminal apparatus further comprises means for receiving the image information transmitted from said scanner apparatus.

12. A central apparatus having means for, by connecting to communicating means, performing communication, and storing means for storing image information received via said means, comprising: means for, when a transmitting instruction including location information is received, transmitting the image information stored in a location in said storing means indicated by the location information included in the received transmitting instruction.

13. The central apparatus as set forth in claim 12, further comprising:
summary document generating means having means for, by using received image information, generating summary image information whose information amount is smaller than said image information, and means for generating a summary document including location information indicative of a location in said storing means in which said image information is stored and the generated summary image information; and
E-mail processing means having means for generating a summary E-mail by attaching the generated summary document to an E-mail, and means for transmitting the generated summary E-mail.

14. A terminal apparatus having means for, by connecting to communicating means, performing communication, comprising:
means for receiving image information;
summary document generating means having means for, by using the received image information, generating summary image information whose information amount is smaller than said image information, and means for generating a summary document including location information indicative of a location in which said image information is stored and said summary image information; and
E-mail processing means having means for generating a summary E-mail by attaching the generated summary document to an E-mail, and means for transmitting the generated summary E-mail.

15. A terminal apparatus having displaying means, comprising summary document processing means for displaying onto said displaying means said summary image information and/or character information included in a summary document which includes summary image information and/or character information and location information corresponding to image information.

16. The terminal apparatus as set forth in claim 15, further comprising means for, by connecting to communicating means, performing communication,
wherein said summary document processing means comprises: means for accepting input of a receiving instruction for requesting reception of image information; and means for, when said receiving instruction is inputted, transmitting a transmitting instruction including the location information corresponding to the image information requested to be received.

17. A scanner apparatus having means for, by connecting to communicating means, performing communication, generating image information by reading an image of an original, transmitting the image information via said means, comprising:
summary document generating means having means for, by using said image information, generating summary image information whose information amount is smaller than said image information, and means for generating a summary document including location information indicative of a location in said storing means in which said image information is to be stored and said summary image information; and
E-mail processing means having means for generating a summary E-mail by attaching the generated summary document to an E-mail, and means for transmitting the generated summary E-mail.

18. An image information distributing system in which a scanner apparatus for generating image information by reading an image of an original and transmitting said image information, a central apparatus for receiving and storing the image information transmitted from said scanner apparatus, and one or a plurality of terminal apparatus for receiving the image information transmitted from said central apparatus are connected via communicating means,
wherein said scanner apparatus, said central apparatus and said terminal apparatus comprises processors, and any of the processors is capable of performing operations of:
generating, by using image information generated by said scanner apparatus, summary image information whose information amount is smaller than said image information;
generating a summary document including location information indicative of a location in which said image information generated by said scanner apparatus is stored and said summary image information;
generating a summary E-mail by attaching the generated summary document to an E-mail; and
transmitting the generated summary E-mail to said terminal apparatus.

19. The image information distributing system as set forth in claim 18, wherein said operation of generating summary document further includes operations of:
determining whether character information is included in said image information or not; and
in the case where character information is included in said image information, making said character information to be included in said summary document.

20. The image information distributing system as set forth in claim 19, wherein
said terminal apparatus comprises displaying means,
said operation of generating summary document is performed by said processor provided on said terminal apparatus, and
said processor is further capable of performing operation of displaying summary image information and/or character information included in the summary document onto said displaying means.

21. The image information distributing system as set forth in claim 20, wherein
said operation of generating summary document performed by said processor provided on said terminal apparatus further includes operations of:
accepting input of a receiving instruction for requesting reception of image information corresponding to said summary image information and/or said character information; and
when said receiving instruction is inputted, in response to the summary image information and/or character information corresponding to the image information requested to be received, transmitting to said central apparatus a transmitting instruction including the location information included in the received summary document, and
said processor provided on said central apparatus is capable of performing operation of, when the transmitting instruction is received, transmitting image information stored in a location indicated by the location information included in the received transmitting instruction to the terminal apparatus which has transmitted the received transmitting instruction.

22. The image information distributing system as set forth in claim 21, wherein said operation of generating summary document and operation of generating and transmitting summary E-mail are performed by said processor provided on said central apparatus.

23. The image information distributing system as set forth in claim 21, wherein said operation of generating summary document and operation of generating and transmitting summary E-mail are performed by said processor provided on said scanner apparatus.

24. The image information distributing system as set forth in claim 21, wherein
said processor provided on said scanner apparatus is capable of performing operation of transmitting said image information to a predetermined terminal apparatus,
said operation of generating summary document and operation of generating and transmitting summary E-mail are performed by said processor provided on said predetermined terminal apparatus, and
said processor provided on said predetermined terminal apparatus is further capable of performing operation of receiving the image information transmitted from said scanner apparatus.

25. A central apparatus having means for, by connecting to communicating means, performing communication, and storing means for storing image information received via said means, comprising a processor capable of performing operation of, when a transmitting instruction including location information is received, transmitting image information stored in a location in said storing means indicated by the location information included in the received transmitting instruction.

26. The central apparatus as set forth in claim 25, wherein said processor is further capable of performing operations of:
generating, by using received image information, summary image information whose information amount is smaller than said image;
generating a summary document including location information indicative of a location in said storing means in which said image information is stored and the generated summary image information;
generating a summary E-mail by attaching the generated summary document to an E-mail; and
transmitting the generated summary E-mail.

27. A terminal apparatus having means for, by connecting to communicating means, performing communication, comprising a processor capable of performing operations of:
receiving image information;
generating, by using received image information, summary image information whose information amount is smaller than said image information;
generating a summary document including location information indicative of a location in said storing means in which said image information is stored and said summary image information;
generating a summary E-mail by attaching the generated summary document to an E-mail; and
transmitting the generated summary E-mail.

28. A terminal apparatus having displaying means, comprising a processor capable of performing operation of displaying onto said displaying means summary image information and/or character information included in a summary document which includes summary image information and/or character information and location information corresponding to image information.

29. The terminal apparatus as set forth in claim 28, further comprising means for, by connecting to communicating means, performing communication, wherein said operation further includes operations of:
accepting input of a receiving instruction for requesting reception of image information; and
when said receiving instruction is inputted, transmitting a transmitting instruction including the location information corresponding to image information requested to be received.

30. A scanner apparatus having means for, by connecting to communicating means, performing communication, generating image information by reading an image of an original, transmitting the image information via said means, comprising a processor capable of performing operations of:
generating, by using said image information, summary image information whose information amount is smaller than said image information;
generating a summary document including location information indicative of a location in which said image information is stored and said summary image information;
generating a summary E-mail by attaching the generated summary document to an E-mail: and
transmitting the generated summary E-mail.

31. A computer memory product in which a computer program for causing a computer to receive and store image information is recorded, said computer comprising means for, by connecting to communicating means, performing communication and storing means for storing information,
said computer program comprising the step for, when a transmitting instruction including location information is received, causing the computer to transmit image information stored in a location indicated by said location information.

32. A computer memory product in which a computer program for causing a computer to transmit/receive information is recorded, said computer comprising means for, by connecting to communicating means, performing communication, said computer program comprising the steps for:
causing the computer to receive image information;
causing the computer to generate, by using the received image information, summary image information whose information amount is smaller than said image information;
causing the computer to generate a summary document including location information indicative of a location in which said image information is stored and said summary image information;
causing the computer to generate a summary E-mail by attaching the generated summary document to an E-mail; and
causing the computer to transmit the generated summary E-mail.

33. A computer memory product in which a computer program for displaying information is recorded, said computer comprising displaying means,
said computer program comprising the step for causing the computer to display onto said displaying means summary image information and/or character information included in a summary document which includes the summary image information and/or character information and location information corresponding to image information.
